(19) United States
(12) Patent Application Publication
(10) Pub. No.: US 2005/0082854 A1
(43) Pub. Date: Apr. 21, 2005

(54) Sanitary waste pickup device

(76) Inventor: Leonard L. Barr, Littleton, CO (US)

Correspondence Address: Barber Legal, P.O. Box 16220, Golden, CO, 80402-6004, US

(21) Appl. No.: 10/687,726

(22) Filed: Oct. 16, 2003

(51) Int. Cl. A01K 29/00; E01H 1/12

(52) U.S. Cl. 294/1.4

(57) ABSTRACT

A two part waste pickup device in which a pick up tool cooperates with a sanitary container to allow one handed pickup and containment of pet wastes. An interior tube inside a hollow tube have disengaging springs with stops inside the hollow tube and on the solid tube to push a shuttle plate over spikes on a fixed plate attached to the hollow tube; the spikes may impale animal waste to be collected and placed in a plastic-bag-lined receptacle cup (the sanitary container), a seal on the upper lip confines materials and odors. The shuttle plate engages detents located on the interior of the receptacle cup. The spring urges the shuttle plate upwards against the detents and the bottom of the fixed plate downwards against the lip of the cup, resulting in the cup and hand tool portion being clamped together.

### FIELD OF THE INVENTION

This invention relates generally to animal waste pickup and specifically to animal waste pickup devices which may be used one-handed.

### STATEMENT REGARDING FEDERALLY FUNDED RESEARCH

This invention was not made under contract with an agency of the US Government, nor by any agency of the US Government.

### BACKGROUND OF THE INVENTION

This invention relates generally to animal waste pickup and specifically to animal waste pickup devices which may be used one-handed, on virtually any surface, and are sealed for indoor storage, and can be used more than one time without dumping.

In the distant past, the best way to reach a leaf, paper, or waste dropped on the ground was to bend down and physically pick it up. The search for an easy way to remove objects on the ground with minimal effort has sparked the interest of many inventors, but an enabling device whereby a user can manipulate and retrieve an object without bending down, while not having to come into physical contact with the object after retrieval, can be an elusive goal. Several patents show some characteristics of manipulation and retrieval from a standing position.

For the typical pet owner, the situation has become exacerbated in recent years due to the nature of modern pet ownership. Most owners cannot allow their pets to roam free in a run or yard anymore. Instead, a daily or twice daily walk in the neighborhood or park is now the norm, and the pet is expected to go to the bathroom during this time. This has several negative impacts. First is the requirement that the pet be leashed at all times, which means that in addition to attempting to pick up the waste in a sanitary manner, it must be done one handed while the other hand holds a leash which is being tugged upon by an animal eager to leave the immediate area quickly. Thus large tools or two handed tools are almost out of the question. A second issue is that in addition to picking up the waste in public, it must be conveyed thereafter for a distance in a sanitary manner. This can prevent pet owners from carrying out errands during their walks.

The tried and true solution is the inside out plastic bag which is used as a glove while bending over, then the bag is reverted to normal configuration with the pet waste inside. This does, however, end up with the user conveying a plastic bag of pet waste until at least the next trash receptacle.

Certain patent references fall into a group which consists of patents on devices so dissimilar from the present invention as to be of little or no references. U.S. Pat. No. 6,196,600 issued Mar. 6, 2001 to Miller for ANIMAL WASTE SCOOPING AND DISPOSAL DEVICE, and U.S. Pat. No. 6,068,311 issued May 30, 200 to Jones for SANITARY PICKUP DEVICE, and U.S. Pat. No. 6,003,913 issued Dec. 21, 1999 to Flumiani for REFUSE COLLECTION DEVICE fall into this category. They provide some overview of what is happening in the area.

A second group of patents are ones which cover devices of the “hand tool” or “pickup” type. U.S. Pat. No. 5,642,911 issued Jul. 1, 1997 to Gatch for LITTER RETRIEVING TOOL, and U.S. Pat. No. 4,422,681 issued Dec. 27, 1983 to Laroche for ANIMAL EXCREMENT PICKER, and U.S. Pat. No. 4,081,192 issued Mar. 28, 1978 to Jones for TRASH PICKER, and U.S. Pat. No. 3,633,958 issued Jan. 11, 1972 to Mesrobian for LEAF PICKER all fall into this category. All of these devices have differences from the hand tool to the present invention and more importantly lack cooperation structures for a sealed receptacle cup and thus for easy one handed usage. For example, the '911 patent teaches a device which may allow a dangling bucket but must be used two handedly with the bucket, and does not have any means to carry a sealed sanitary container, nor allow real cooperation between a bucket and the device. The '681 patent teaches a device with a magnetically attached plate across the bottom: the user is expected to pry off the plate before each use, and it can be used only one time before it must be cleaned. It further has a moving plate with spikes. The '192 patent shows another device with a moving plate with spikes. The '958 patent teaches a device with no sanitary container.

A third group of patents are ones that generally concern encasement or boxing of pet waste. U.S. Pat. No. 6,039,369 issued Mar. 21, 2000 to Stahovic for ANIMAL EXCREMENT COLLECTION DEVICE AND COLLECTING TOOL teaches a device with two hand tool parts and a bag suspended from one of them. The user is supposed to scrape the animal excrement free from the first tool and into the bag. This and other “bag” type patents reach little or nothing about the present device.

U.S. Pat. No. 5,702,137 issued Dec. 20, 1997 to Gutierrez for STAFF OR STICK FOR RECOLLECTION ORGANIC WASTE FROM DOMESTIC ANIMALS SUCH AS DOGS OR CATS teaches a box having a pie shaped cross section (see FIG. 7) which open up like a pair of jaws and then closes. While this one at least encases a single instance of animal waste, it does not disclose an independent cup and a sterile seal, even when combined with a patent from the previous group.

U.S. Pat. No. 5,628,537 issued May 13, 1997 to Keimer for PET WASTE PICKUP AND DISPOSAL APPARATUS is similar to the '137 patent (just previous), i.e. it has jaws which open and close. This is the only one with a container, but the container is really for the entire device, it is not a solid and sealed pet waste receiver.

Finally, U.S. Pat. No. 4,286,816 issued Sep. 1, 1981 to Tobias for DEVICE FOR COLLECTION AND DISPOSAL OF PET WASTE at least teaches some sort of cup shaped portion of the hand tool. However, this cup is obviously not solid and detachable; it is used differently, and has numerous structural differences. In fact, this is actually another “bag” type device, unrelated to the present invention. Note that FIG. 2 shows springs and what appear to be “spikes” at the bottom. In fact, this is a sharpened grill work, not spikes: the user is expected to push the pet waste through the grill work.

It would be advantageous to eliminate some of the moving parts of the reference patents, in order to provide simpler, more efficient and less expensive operation.

It would further be advantageous to provide a “multi-use” capability: certain references do not allow more than one use before the device must be cleaned off.

It would be advantageous to have a device which may be used one handed.

It would be further advantageous to have a device which could be used one handedly to both pick up and sanitarily contain pet wastes.

It would also be advantageous if such a device may be self cleaning, with the potentially dirty portions of the device safely contained so that externally no pet waste matter might be found.

It would be advantageous to have a device, which utilizes and incorporates a receptacle cup with a sealed upper lip to confine odors, a plastic bag to hold the waste, a removable bottom on the receptacle cup for removing the bag and detents inside the receptacle cup to attach and disengage the receptacle cup from the hand tool.

Finally, it would be advantageous to provide a device which can be used in any of three modes: with a sealed cup only, with a cup and bag, or as a cylindrical bag holder only.

### SUMMARY OF THE INVENTION

General Summary

The invention comprises a two part device in which a pick up tool cooperates with a sanitary container to allow one handed pickup and containment of pet wastes.

A first handle permits that a force be placed against an opposing handle, the first handle connects to a solid tube inside a hollow tube to which the second handle is attached. Disengaging springs with stops inside the hollow tube and on the solid tube in turn push a shuttle plate over spikes that are embedded on a fixed plate attached to the hollow tube; the spikes may impale animal waste to be collected and placed in a plastic-bag-lined receptacle cup (the sanitary container), the cup has a removable bottom and a seal on the upper lip for confining materials and odors therewithin.

The shuttle plate engages detents located on the interior of the receptacle cup, extending the shuttle plate downwards in reference to the spikes and thus expanding a spring inside the hollow tube. The spring urges the shuttle plate upwards against the detents and the bottom of the fixed plate downwards against the lip of the cup, resulting in the cup and hand tool portion being clamped together, this may hold the sanitary waste pickup device to the receptacle cup and confine the animal waste in the container or in the plastic bag. The plastic bag may be released through a removable bottom of the cup, or by releasing the cup from the pick-up device and disposing of the bag manually. The sanitary waste pickup device may disengage any animal waste from the spikes by motion of the shuttle plate from its neutral/medial/rest position relatively down the spikes to the very tip of the spikes. The return spring then returns the shuttle plate to a neutral position in the solid tube and resumption of animal waste pickup may continue, or the device may be left with the shuttle plate urged upwards against the bottom of the detente with the device sealed.

Summary in Reference to Claims

It is therefore one aspect, advantage, objective and embodiment of the invention to provide a sanitary waste pickup device comprising: a receptacle cup with a depth, a bottom, an interior surface, a lip, and at least one detente on the interior surface located at approximately one half the depth of the receptacle cup; a shuttle plate dimensioned and configured to moveably accept the spikes through a plurality of apertures, each spike passing through an aperture of the shuttle plate, the shuttle plate dimensioned and configured so it may pass the detente on the cup if a first force is applied to the shuttle plate, and may not pass the detente if a second lesser force is applied; a fixed plate with embedded parallel spikes projecting therefrom; a void at the center of the fixed plate, a solid tube passing therethrough, the solid tube having a first end attached to the shuttle plate and a second end having a first handle attached thereto, the solid tube having a first stop; a hollow tube attached to the fixed plate and surrounding the solid tube slidably, and having at least first and second catches and at least two springs, disposed within the hollow tube, allowing tension and release against the first catch during relative movement of the solid tub within the hollow tube stops; the first handle, forming a physical unity whereby the solid tube, and shuttle plate urging the solid tube downwards sets in motion the shuttle plate to scrape clean the spikes as the shuttle plate moves downwards; and a second handle attached to the hollow tube.

It is therefore a second aspect, advantage, objective and embodiment of the invention to provide a sanitary waste pickup device wherein the bottom of the receptacle cup is removable.

It is therefore another aspect, advantage, objective and embodiment of the invention to provide a sanitary waste pickup device wherein the invention is a metal material.

It is therefore another aspect, advantage, objective and embodiment of the invention to provide a sanitary waste pickup device wherein the invention is a plastic material.

It is therefore another aspect, advantage, objective and embodiment of the invention to provide a sanitary waste pickup device wherein the invention is a wood material.

It is therefore another aspect, advantage, objective and embodiment of the invention to provide a sanitary waste pickup device wherein the receptacle cup is cylindrical.

It is therefore another aspect, advantage, objective and embodiment of the invention to provide a sanitary waste pickup device wherein the receptacle cup is square in horizontal cross-section.

It is therefore another aspect, advantage, objective and embodiment of the invention to provide a sanitary waste pickup device wherein the second stop prevents the shuttle plate from passing beyond the ends of the spikes.

It is therefore another aspect, advantage, objective and embodiment of the invention to provide a sanitary waste pickup device wherein a plastic bag lines the cup.

It is therefore another aspect, advantage, objective and embodiment of the invention to provide a sanitary waste pickup device wherein the first handle is horizontal and attached to the solid tube at an intermediate point of the first handle.

It is therefore another aspect, advantage, objective and embodiment of the invention to provide a sanitary waste pickup device wherein the second handle may encircle the first handle.

It is therefore another aspect, advantage, objective and embodiment of the invention to provide a sanitary waste pickup device further comprising: a seal disposed at the lip of the cup or the fixed plate.

It is therefore another aspect, advantage, objective and embodiment of the invention to provide a sanitary waste pickup device further comprising: a second detente located on the interior surface of the cup.

It is therefore another aspect, advantage, objective and embodiment of the invention to provide a sanitary waste pickup device wherein the second detente is located nearer to the lip of the cup than the first detente.

It is therefore another aspect, advantage, objective and embodiment of the invention to provide a sanitary waste pickup device further comprising: a seal located at the lip of the cup or on the fixed plate.

### BRIEF DESCRIPTION OF THE DRAWINGS

FIG. 1 is a front view of the first embodiment of the invention, showing the side view of the sanitary waste pickup device.

FIG. 2 is a front view of the second embodiment of the invention, showing interior sections via transparent hollow tube of the sanitary waste pickup device.

FIG. 3 is a top view of the first embodiment of the invention, showing the top view of the sanitary waste pickup device with certain parts omitted.

FIGS. 4a through 4f are front and right side views of various elements of the first embodiment of the invention, showing the outer hollow tube and solid tube for the sanitary waste pickup device.

FIGS. 5a-5c are top and right side views of parts the first embodiment of the invention, showing the fixed plate with embedded spikes and side view of a spike of the sanitary waste pickup device.

FIG. 6 is a bottom view of elements the first embodiment of the invention, showing the fixed plate with embedded spikes of the sanitary waste pickup device.

FIGS. 7a and 7b are top and right side views of the first embodiment of the invention, showing the shuttle plate with a plurality of apertures for the sanitary waste pickup device.

FIG. 8 is a front side view of the first embodiment of the invention, showing the receptacle cup with detente.

FIG. 9 is a top side view of the first embodiment of the invention, showing the top view of the receptacle cup with seal.

FIG. 10 is a cross-sectional side view of the preferred embodiment of the invention, with a double detent cup employing a plastic bag.

FIG. 11 is a cross-sectional side view of the preferred embodiment of the invention, with a double detent cup without a bag.

FIG. 12 is a bottom view of the fixed plate with embedded spikes, showing the seal of the preferred embodiment.

FIG. 13 is a cross-sectional side view of an alternative embodiment with detentes of an alternative type, showing the device in use without the bottom.

FIG. 14 is a cross-sectional side view of the receptacle cup only showing the cup in the middle of disassembly.

FIG. 15 is a side cross-sectional view of the hand tool portion in the extreme raised position.

FIG. 16 is a side view of the handles, partially cross-sectional, showing the race of the side rail.

FIG. 17 is a perspective view of the handles.

### INDEX TO REFERENCE NUMERALS

Ref. 50 Handle.
Ref. 51 Handle for opposing pressure.
Ref. 52 Solid tube.
Ref. 53 Hollow tube.
Ref. 54 Fixed plate.
Ref 55 Spikes.
Ref. 56 Shuttle plate with a plurality of apertures.
Ref. 57 Upper spring inside hollow tube.
Ref. 58 Lower spring inside hollow tube.
Ref. 59 Handle bolt.
Ref. 60 Receptacle cup with seal.
Ref. 61 End of handle.
Ref. 62 End of solid tube.
Ref. 63 End of hollow tube.
Ref. 64 Spike terminations
Ref. 65 Fixed plate hole.
Ref. 66 Mounting bolt.
Ref. 67 Apertures.
Ref. 68 Receptacle cup.
Ref. 69 Removable bottom.
Ref. 70 Receptacle cup Seal.
Ref. 71 Stops.
Ref. 72 Plastic bag.
Ref. 73 Detente.
Ref. 74 Base of embedded spikes.
Ref. 100 First detente
Ref. 102 Second detente
Ref. 104 Plastic Bag
Ref. 106 Cylindrical Cup Portion
Ref. 108 Cup Bottom
Ref. 110 ShuttlePlate
Ref. 110′ Shuttle Plate 110 in raised position
Ref. 110″ Shuttle Plate 110 in intermediate position
Ref. 112 Fixed Plate
Ref 114 Spikes
Ref. 116 Seal
Ref 118 Movable Handle
Ref. 120 Lower Handle
Ref. 122 Upper Handle
Ref. 124 Side Rail
Ref. 126 Inner Tube
Ref. 128 First Spring
Ref. 130 Second Spring
Ref. 132 First Stop
Ref. 134 Second Stop
Ref. 136 Third Stop
Ref. 138 Clip
Ref. 140 Outer Tube
Ref. 142 Apertures
Ref. 144 Peripheral Region of Fixed Plate, 112 Bottom

### DETAILED DESCRIPTION

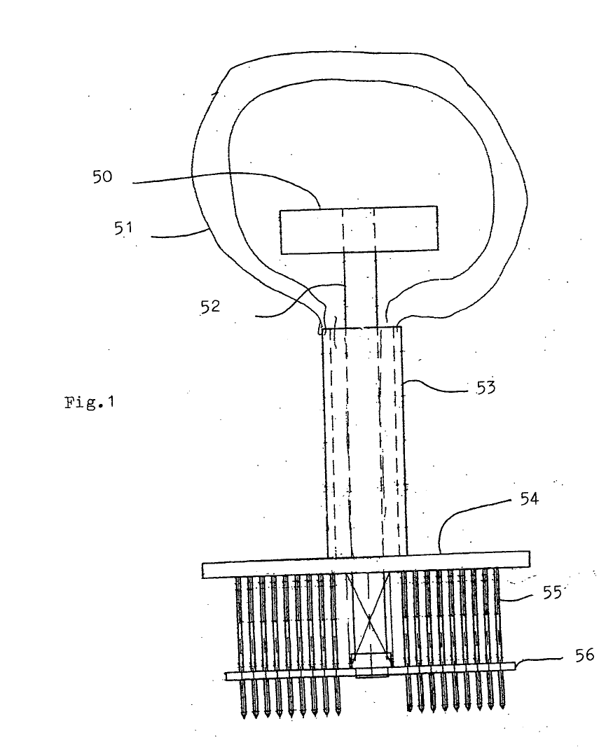

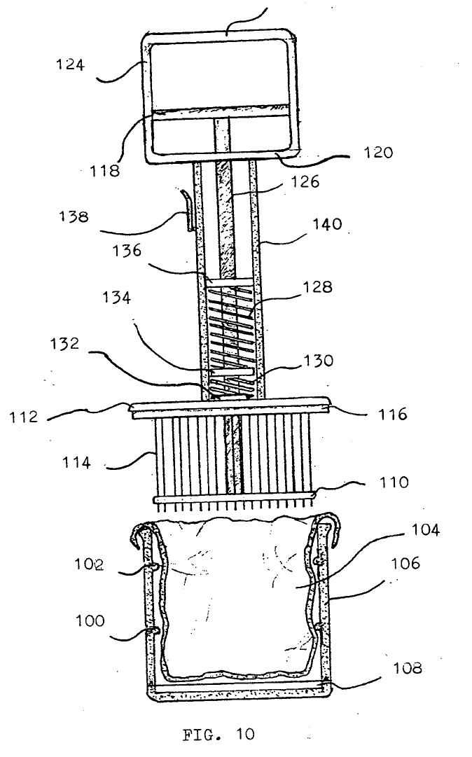

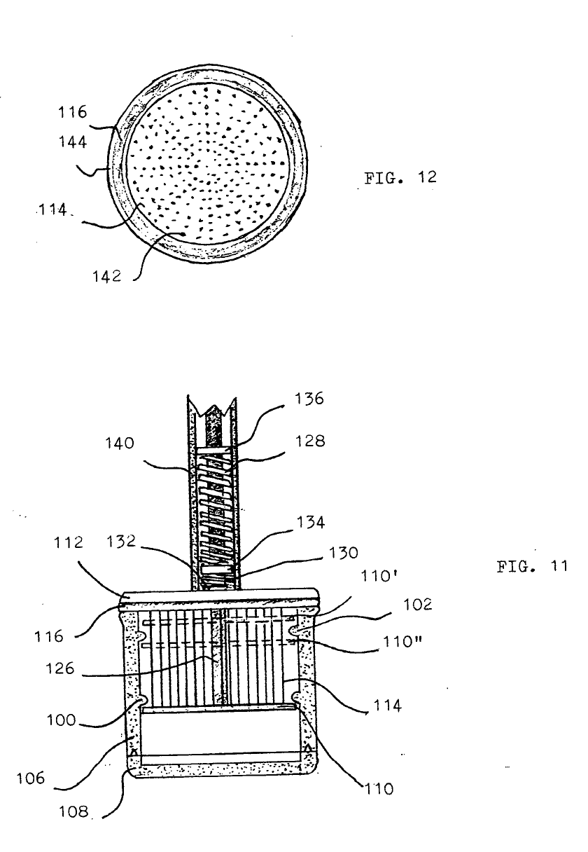

The first embodiment of the sanitary waste pickup device is the front view of FIG. 1. Materials of the invention may be a plastic polymer, metal or combination. The invention may also be wooden materials, composites, etc. In the embodiment of FIG. 1, and in the best mode now contemplated (FIGS. 10-12), certain materials are transparent to allow a view of the working of the device (for example, the hollow tube 53) may be transparent to show any springs inside, while other parts of the invention are not transparent (for example, the sanitary container of later diagrams) so as to occlude any view of the contents of that portion of the device. Embodiments have both shuttle plate 56 and fixed plate 54 transparent, so that a user may look directly through these plates in aiming the device.

A horizontally placed handle 50 is attached and may be connected by means of a bolt, an adhesive, pressure fit, unitary construction, etc, to a vertical solid rod 52 at the mid point of the first handle 50. A second handle 51 may vertically encircle the first handle 50 or in other embodiments may parallel it or be otherwise arranged for one handed pressure on the two handles, and pressure may be applied between the two to urge the solid tube 52 up or down in relation to hollow tube 53. The second handle 51 is connected by the same devices listed in reference to the solid tube 52 or by equivalent devices such as screws or soldering to hollow tube 53 that surrounds the solid tube 52 slidably. The hollow tube 53 is connected to the fixed plate 54 via the same means or equivalents. Parallel spikes 55 are embedded into the fixed plate 54 and project therefrom in the downward direction, the spikes 55 may be dimensioned and configured so as to be moveably accepted by the shuttle plate 56 that may be attached to the solid tube 52.

Solid tube 52 may advantageously be itself hollow in alternative embodiments, or may be a rod, etc.

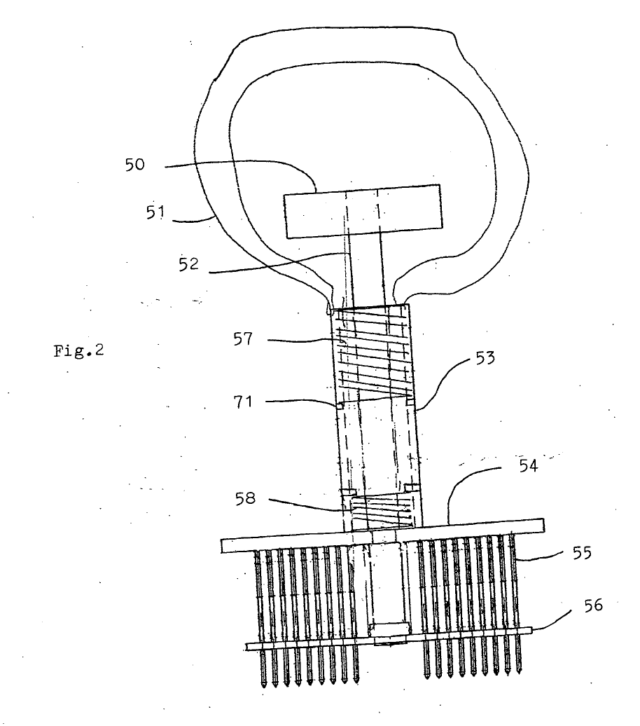

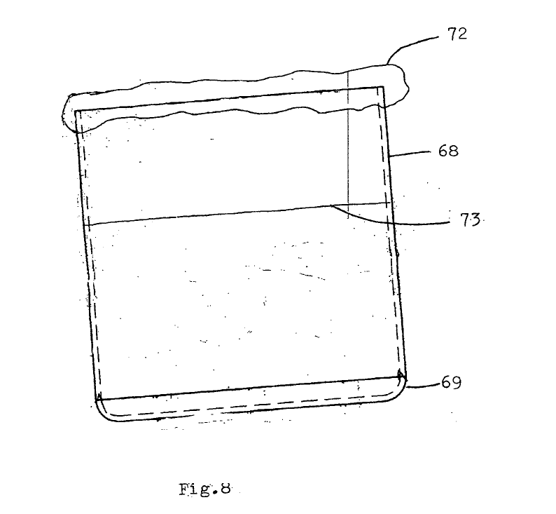

The second embodiment of the device is similar to the first embodiment but features spring action to maintain a closure of the device with the cup portion (FIG. 8) of the device. A front view of the second embodiment of the invention shown in FIG. 2 shows a transparent plastic material used for the hollow tube 53 that reveals the interior where springs 57, 58 and stops 71 are employed. As pressure is applied between the first and second handles 50, 51 the movement of the solid tube 52 is urged against the tension in spring 58 and against the compression in spring 57. The upward movement of the first handle 50 and the solid tube 52 pulls the shuttle plate 56 towards the fixed plate 54 thus further exposing parallel, spaced spikes 55 for potentially impaling waste, leaves, etc. The shuttle plate 56 is dimensioned and configured to moveably accept the spikes 55 through the apertures 74. Pressure is thus placed on spring 57, in the upper part of the hollow tube 53, offered by the coming together of the first handle 50 and second handles 51. Release of pressure between the handles 50, 51 releases the tension in the spring 57 and the action in the hollow tube 53 returns shuttle plate 56 to a neutral or rest position medial the fixed and distal ends of spikes 55, and at least partially scrapes clean the spikes 55 against the shuttle plate. The provision of shuttle plate 56 able to reach the extreme ends of spikes 55 is advantageous: flush to the bottom, complete cleaning of the length of the spike is permitted.

In embodiments, the thickness of shuttle plate 56 may be increased either across substantial areas, or locally about the apertures. This allows the ends of spikes 55 to actually be entirely shrouded when shuttle plate 56 is extended fully, thus increasing cleaning action even further.

Obviously, wider apertures allow easier relative motions and minimize the risk of jamming. Narrower apertures provide a better scraping action of the spikes.

On the other hand, when handles 50, 51 are forced apart (when handle 50 is forced in a downwards direction as sensed in FIG. 2), spring 57 is placed in tension and spring 58 is placed in compression. Shuttle plate 56 is forced downwards relative to spikes 55, thus further scraping clean the spikes 55. Obviously release of this force allows springs 57, 58 to return to the rest position.

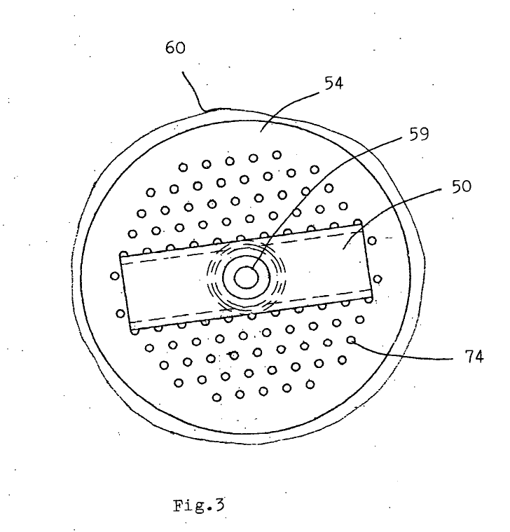

The top view of the sanitary waste pickup device FIG. 3 shows the first handle 50 and its relative size to the transparent fixed plate 54 and the receptacle cup 60. FIG. 3 also indicates the handle bolt 59 and the base of the embedded spikes 74.

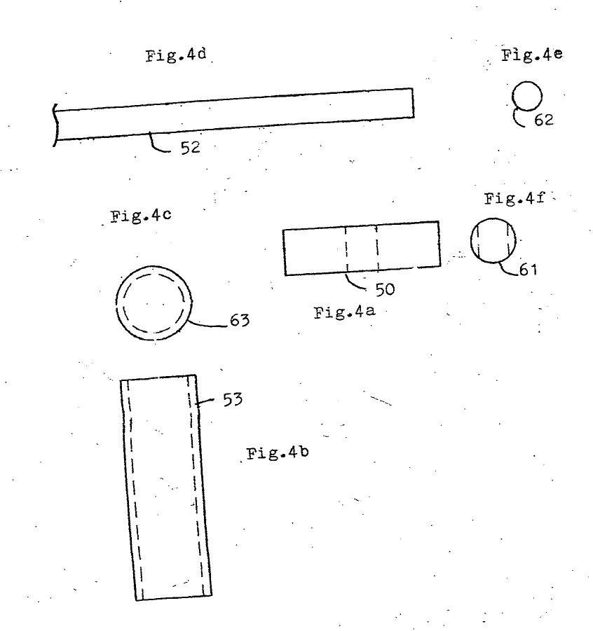

The first handle 50, solid tube 52, and hollow tube 53 are shown in FIGS. 4a-4f. The materials used in these elements of the sanitary waste pickup device may be a plastic polymer, metal or a combination of both materials. The slidable relationship between the solid tube 52 and the hollow tube 53 may warrant a smooth surface on the outer surface of the inner tube 52 and the outer tube 53. To repeat, solid (inner) tube 52 may in embodiments be hollow.

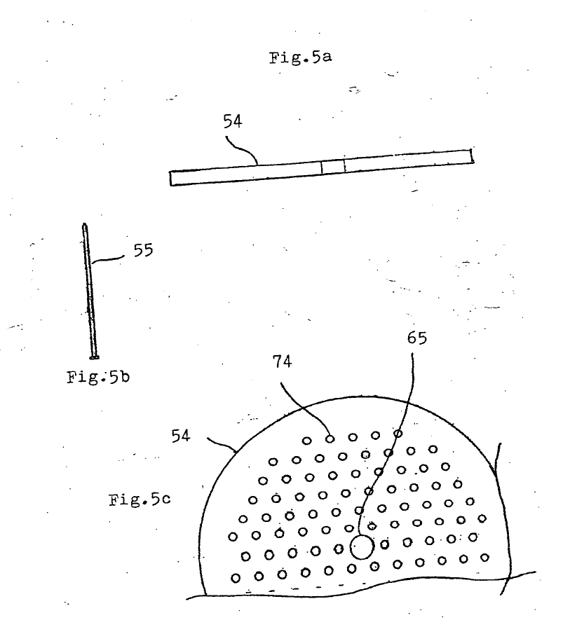

The top side and right side views of the fixed plate 54 and the right side view of the spike 55 are seen in FIG. 5. The spikes 74 are embedded to the base of the fixed plate 54 and may be adhered to the fixed plate 54 via glue, solder, unitary construction, pressure fit, or otherwise attached together. The spikes are parallel, dimensioned and configured and may be moveably accepted into and through the shuttle plate FIG. 1, Ref. 56. The fixed plate hole 65 at the center of the fixed plate 54 allows the solid tube 52 to pass slidably therethrough.

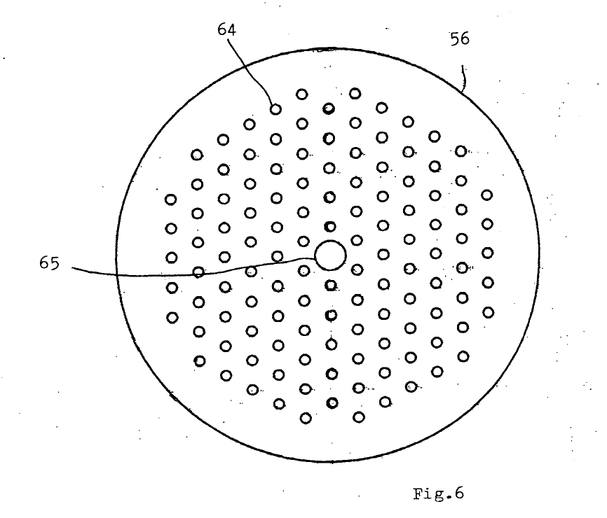

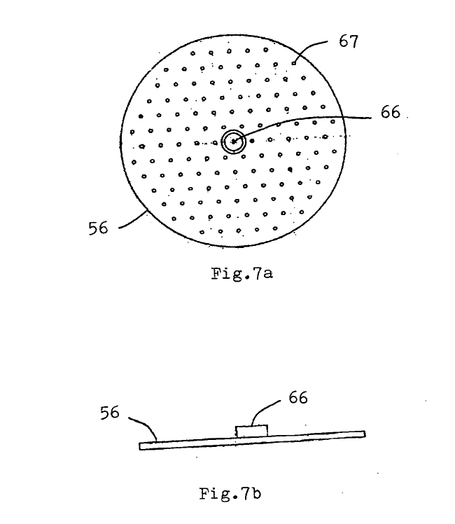

The bottom view of FIG. 6 shows the fixed plate 54, the spike terminations 64 (the distal ends of spikes 55) on the fixed plate 54 as well as the fixed plate hole 65. FIGS. 7a and 7b are top and right side views of the first embodiment of the invention, showing the shuttle plate 56 with a plurality of apertures 67 for the sanitary waste pickup device.

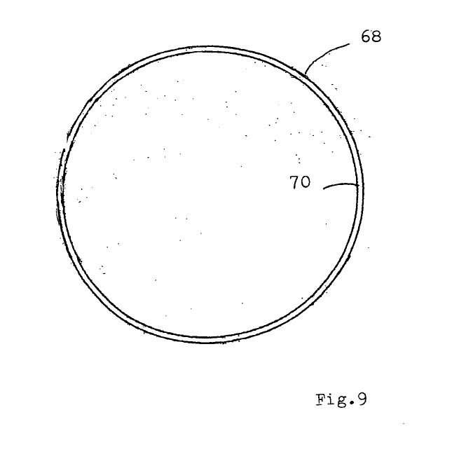

FIG. 8 is a front side view of the first embodiment of the invention, showing the receptacle cup with detente. The part of the invention is important to understanding of the entire device. Sanitary containers are necessary to allow sanitary transportation of pet waste after collection, and one handed use is important so as to allow usage while holding a leash. Both objectives are fulfilled by means of the close physical cooperation between the hand tool part of the invention discussed previously (in particular, the shuttle plate 56) and the receptacle cup 68. Cup 68 has in the first embodiment shown and in the presently preferred embodiment (FIGS. 10-12) has removable bottom 69 and seal 70 (see FIG. 9). Detente 73 located on the inner surface of the cup 68 is dimensioned and configured very carefully in relation to the size and medial rest position of shuttle plate 56. Shuttle plate 56 may pass detente 73 upon application of a first force. However, application of a second lesser force does not allow shuttle plate 56 to pass detente 73. This second lesser force may, for example be the force exerted by springs 57, 58 when those springs are extended/compressed sufficiently to allow shuttle plate 56 and fixed plate 54 to relatively separate by a modest amount. In storage, the hand tool portion of the device may be inserted into cup 68 and handle 50 pushed downwards, that is, in the direction causing the plates to separate slightly. Shuttle plate 56 may then pass over detente 73, and upon release of the handle, springs 57, 58 urge the periphery or edge of shuttle plate 56 upwards against the bottom of detente 73. This also urges the periphery or edge of fixed plate 54 downwards against seal 70 disposed at the lip of cup 68. The combined pressure between the two plates thus secures the hand tool portion of the device to the cup portion of the device and the second lesser pressure exerted by the springs 57, 58 is insufficient to dislodge this arrangement, on the contrary, the spring action holds the parts disposed together, abutting at the peripheries of the plates.

Detente 73 may be a single bump, catch, stop or similar protrusion from the interior of cup 68 or it may be ridge around the interior, or plurality of such bumps, or other equivalent devices.

The proportions of the cup, spikes, springs and stops may allow the shuttle plate to be stopped from further downward motion beyond the distal ends of the spikes. It will be appreciated that pushing the shuttle plate beyond the spike ends might allow it to become misaligned, so that it would require manual manipulation to return the spikes to the apertures.

FIG. 10 is a cross-sectional side view of the presently preferred embodiment and best mode now contemplated for practicing of the invention, with a double detent cup employing a plastic bag.

First detente 100 acts to secure shuttle plate 110 as discussed in reference to the first detente 73 of the first embodiment shown in FIGS. 1 through 9. Second detente 102, however, holds shuttle plate 112 in a loose position which does not seal the receptacle cup lip against the fixed plate. This arrangement has the following advantage. In use, the owner may easy urge shuttle plate 112 into the loose intermediate position between the two detentes 100, 102. The plastic bag 104 is then not secured at any location: it is not trapped between fixed plate 112 and the lip of the receptacle cup, nor is it held at any detente. If cup bottom 108 is removed, bag 104 may freely “flow” out between the detents 100, 102, and fall away under it's own weight.

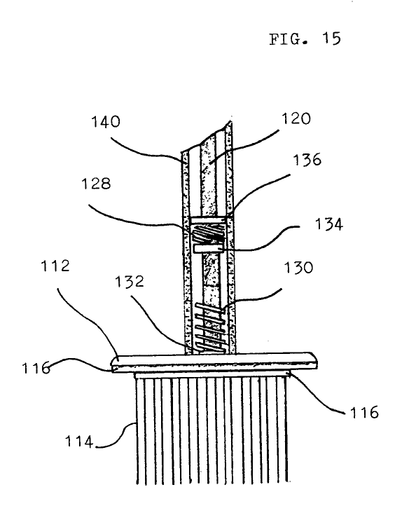

The three modes of operation of the device (cup only, cup and bag, or cylindrical cup portion and bag) may now be seen more clearly as well. If cup bottom 108 is removed, cylindrical portion 106 remains, with detentes 100, 102. The use of the device remains the same but the capacity may be substantially increased merely by increasing the size of bag 104 (substituting a larger bag). FIG. 13 is a cross-sectional side view of an alternative embodiment with detentes of an alternative type, showing the device in use without the bottom. FIG. 14 is a cross-sectional side view of the receptacle cup only showing the cup in the middle of disassembly from one mode to another. In the embodiment pictured, a small groove 150 and tongue 152 cooperate to cause the joining.

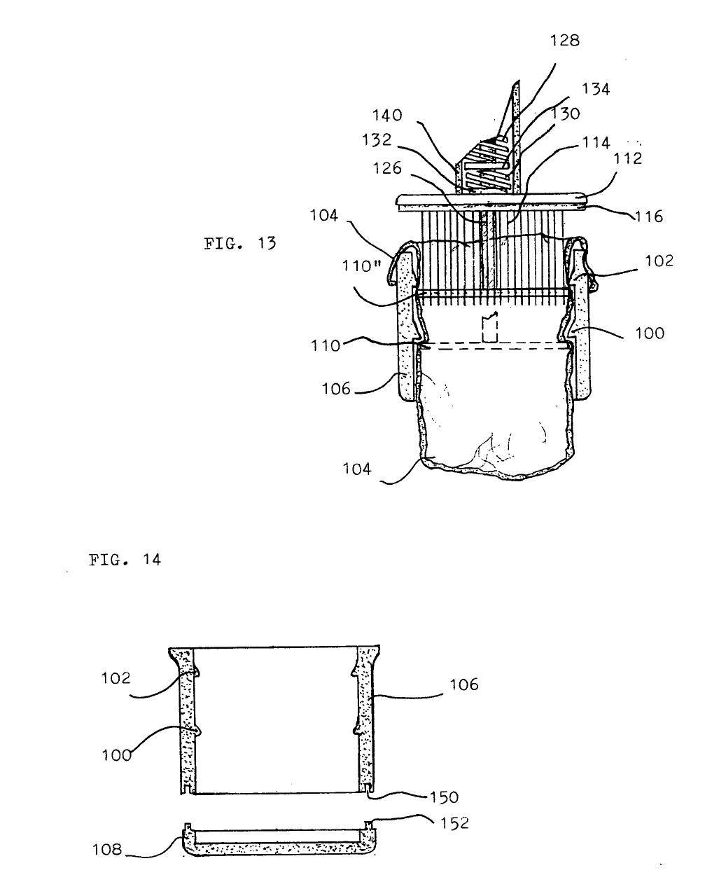

Additional advantages of the preferred embodiment may also be seen in FIG. 10. Seal 116 is borne at the periphery of fixed plate 112, in a manner seen more clearly in FIG. 12. FIG. 12 is a bottom view of the fixed plate 112 with embedded spikes 114, showing the seal 116 of the preferred embodiment. Apertures 142 may be seen, as well as peripheral plate region 144. This peripheral region is an annular area on the bottom surface of fixed plate 112 which provides a surface for seal 116. Seal 116 may be seated in a seal race (a shallow circular groove), may be adhered by glue or other means to fixed plate 112 or may otherwise be secured.

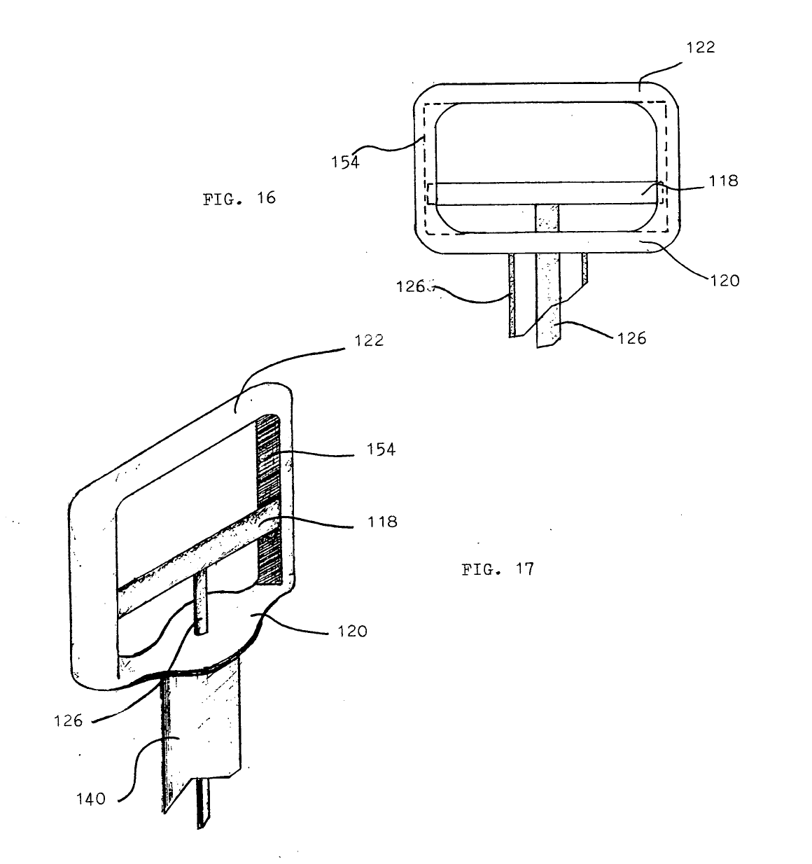

Returning to FIG. 10, another advantage of the best mode now contemplated is the use of three handles: top handle 122, movable handle 118, and bottom handle 120. The device is specifically designed for easy, sanitary one-handed use. FIG. 16 is a side view of the handles, partially cross-sectional, showing the race 154 of the side rail. FIG. 17 is a perspective view of the handles. The user may apply force sufficient to bring the shuttle plate above the first detente and below the second detente. This in turn results in the hand tool and cup being very loosely attached together, with the shuttle plate free to move back and forth between the two detents. Additional positions may be achieved. When movable handle 118 is compressed (squeezed, urged) with/to top handle 122, shuttle plate 110 rises to its highest position. When movable handle 118 is squeezed with bottom handle 120, shuttle plate 110 is lowered to its lowest position. Release causes the device, handles, springs and shuttle plates, to return to the relaxed, rest or intermediate position. Provision of three handles expedites all these motions, as the human hand is adapted to a one-handed compression of two handles towards each other, and ill adapted to a one-handed separation of two handles. Side rail 124 may be used to orient and retain the handles in their respective configurations: it may be structural, or it may enclose the ends of movable handle 118 in a race/groove. FIG. 11 is a cross-sectional side view of the preferred embodiment of the invention, with a double detent cup without a bag, showing the results of this. Shuttle plate 110 is shown in the “sealing” position in which it is extended to the extreme ends of spikes 114 (cleaning the entire length of spikes 114 but not slipping off and out of alignment therewith). Shuttle plate 110′ shows the plate in an upward position above detente 102. Shuttle plate 110″ shows the plate in an intermediate position between detentes 100, 102. It will be appreciated that there is only one shuttle plate 110, the use of prime and double prime notation (110′, 110″) and the ghost representation of shuttle plate 110 provides a clear comparison of plate locations. FIG. 15 is a side cross-sectional view of the hand tool portion in the extreme raised position, with the compression/extension of the two springs now reversed.

FIGS. 10 and 11 show yet another advantage of the presently preferred embodiment, the minimization of spring and stop technology within outer tube 140. Spring 128 is compressed against stop 136 by stop 134 when shuttle plate 110 is raised, while spring 130 is compressed against stop 132 by the stop 134 when shuttle plate 110 is lowered: this latter configuration may be seen in FIG. 11, while the rest configuration with shuttle plate 110 at its resting/intermediate position may be seen in FIG. 10.

A final aspect of the best mode now contemplated is the provision of clip 138 on the side of outer tube 140. This clip may advantageously be used to hold spare plastic bags, to hold a pet leash, or may even be configured and dimensioned to hold cup bottom 108 when the device is used in a mode which does not employ it as a cup bottom.

However, as noted second detente may be employed to profitably increase the flexibility of use of the preferred embodiment. Second detente 102 may as stated previously and shown herein be located above first detente 100 at a location higher on the interior surface of cylindrical cup part 106.

A bag may be employed as a liner in any of the embodiments of the invention, but in the two detente embodiment, the removable bottom may be taken off, exposing the bottom of the bag. When the shuttle plate is disposed between the two detents, a small gap will exist between the interior surface of the cup and the periphery/edge of the shuttle plate, through which gap the bag may freely flow downwards and thus remove itself from the interior of the cup without further user intervention. The user may hold the entire device over a trash container/dust bin, remove the bottom, and pull the handles sufficiently to bring the shuttle plate above one detente and below the other. The weight of any materials in the bag will then pull the bag from between the fixed plate and seal (which will not be in contact in the loosely attached position), past the first detente, past the shuttle plate edge, past the second detente, and down into the trash can: no two components of the two parts of the device will be in contact together.

A seal may be incorporated for sanitation, and to additionally prevent the escape of odors, at the location at which inner tube 126 passes through fixed plate 112.

Finally, in another embodiment, there may be no bottom whatsoever: the receptacle may be a cylinder sealed at the top by the seal, with a plastic bag to keep wastes contained at the bottom end.

The nature of the spikes may also vary to suit the embodiment, usage and manufacturing needs. The spikes may be generally cylindrical, tapered, may have flat, rounded or pointed ends, and so on. The spikes may have a round, elliptical or oval cross-section, a square cross-section, triangular, polygonal, or may comprise an I-beam, H-beam, X-beam, T-beam or similar irregular configuration.

To use the device for waste collection, the device, both major components attached together in storage position, may be placed on the ground with the cup bottom in a clean location. The user will remove the hand tool portion by squeezing the handles together, thus applying a force sufficient to lift the shuttle plate past the one or more detents of the embodiment utilized and clear the hand tool from the cup. While squeezing to bring the shuttle plate relatively high on the spikes (or even to the underside of the fixed plate), the device is stabbed onto the material to be cleaned up: leaves, litter, pet waste, etc. The device is then returned to the cup, where the squeeze of the handles is reversed: the shuttle plate is forced downwards. It may pass over the one or more detents until its maximum downward extension is reached and the materials impaled on the spikes expelled therefrom. Upon release of the handles, the shuttle plate will attempt to return to rest position, bumping into the detents. The fixed plate will be drawn downwards to impact the lip of the cup and the hand tool and cup will once again be in storage position, locked together. Wastes inside the container will be sanitarily isolated in a closed space with no air gaps to allow escape of odors, insects, bacteria, viruses, etc.

The present invention has been disclosed so as to allow one skilled in the art to practice the invention without undue experimentation, but nothing in this disclosure is to be taken to limit the scope of the invention: the scope of the invention may be understood from the appended claims only. The invention as disclosed herein is subject to many modifications, equivalents, improvements, and substitutions without departing from the scope of the invention as claimed below.

1. A sanitary waste pickup device comprising:
a receptacle cup with a depth, a bottom, an interior surface, a lip, and at least one detente on the interior surface at a first distance below the lip;
a fixed plate with embedded parallel spikes projecting therefrom, the spikes having a length slightly greater than the first distance;
a shuttle plate dimensioned and configured to moveably accept the spikes through a plurality of apertures, each spike passing through an aperture of the shuttle plate, the shuttle plate dimensioned and configured so it may pass the detente on the cup if a first force is applied to the shuttle plate, and may not pass the detente if a second lesser force is applied;
a void at the center of the fixed plate, a solid tube passing therethrough, the solid tube having a first end attached to the shuttle plate and a second end having a first handle attached thereto, the solid tube having a first stop;
a hollow tube attached to the fixed plate and surrounding the solid tube slidably, and having at least first and second catches and at least two springs, disposed within the hollow tube, allowing tension and release against the first catch during relative movement of the solid tub within the hollow tube stops;
the first handle, forming a physical unity whereby the solid tube, and shuttle plate urging the solid tube downwards sets in motion the shuttle plate to scrape clean the spikes as the shuttle plate moves downwards;
a second handle attached to the hollow tube.

2. The sanitary waste pickup device of claim 1, wherein the bottom of the receptacle cup is removable.

3. The sanitary waste pickup device of claim 1, wherein the invention is a metal material.

4. The sanitary waste pickup device of claim 1, wherein the invention is a plastic material.

5. The sanitary waste pickup device of claim 1, wherein the invention is a wood material.

6. The sanitary waste pickup device of claim 1, wherein the receptacle cup is cylindrical.

7. The sanitary waste pickup device of claim 1, wherein the receptacle cup is square in horizontal cross-section.

8. The sanitary waste pickup device of claim 1, wherein the second stop prevents the shuttle plate from passing beyond the ends of the spikes.

9. The sanitary waste pickup device of claim 1, further comprising a plastic bag lining the cup.

10. The sanitary waste pickup device of claim 1, wherein the first handle is horizontal and attached to the solid tube at a midpoint of the first handle.

11. The sanitary waste pickup device of claim 1, wherein the second handle may encircle the first handle.

12. The sanitary waste pickup device of claim 1, further comprising: a seal disposed at the lip of the cup.

13. The sanitary waste pickup device of claim 1, further comprising: a second detente located on the interior surface of the cup.

14. The sanitary waste pickup device of claim 13, wherein the second detente is located nearer to the lip of the cup than the first detente.

15. The sanitary waste pickup device of claim 1, further comprising: a seal located at the bottom periphery of the fixed plate.
